(19) United States
(12) Patent Application Publication
(10) Pub. No.: US 2007/0044329 A1
(43) Pub. Date: Mar. 1, 2007

(54) Apparatus and method for locating subterranean objects

(76) Inventors: Kirk D. Mitchell, Wellston, OK (US); Paul E. Whitnah, Wellston, OK (US)

Correspondence Address: DUNLAP, CODDING & ROGERS P.C., PO BOX 16370, OKLAHOMA CITY, OK, 73113, US

(21) Appl. No.: 11/216,501

(22) Filed: Aug. 31, 2005

(51) Int. Cl. G01V 3/08

(52) U.S. Cl. 33/1 E

(57) ABSTRACT

A locating apparatus for designating a location and depth of a subterranean object. The locating apparatus includes an elongated member having a demarcation disposed thereon, a mounting assembly connectable to the subterranean object and to the elongated member such that at least a portion of the elongated member is disposable above ground level for indicating the location and depth to which the subterranean object is buried.

### CROSS REFERENCE TO RELATED APPLICATIONS

Not Applicable

### STATEMENT REGARDING FEDERALLY SPONSORED RESEARCH AND DEVELOPMENT

Not Applicable

### BACKGROUND OF THE INVENTION

1. Field of the Invention

The present invention relates to an object location apparatus, and more particularly, but not by way of limitation, to a subterranean object locating apparatus and method of using same to determine the depth of a buried object.

2. Brief Description of Related Art

Accurate location of subterranean objects, such as buried utilities, is important for excavation. This is particularly true when the utilities intersect roads or other crucial points. Previous methods of locating subterranean objects have included dowsing, digging, probing, sending currents through lines, using magnetic fields, metal detectors and the like. Because of erosion, accretion, unreported excavation and the like, most of the previous methods require the object to be located again for any subsequent excavation. Additionally, all of the prior methods are either unreliable, costly, or labor intensive. Therefore, a need exists for an inexpensive, yet accurate method and apparatus for locating subterranean objects which does not require significant resource allocation. It is to such a method and apparatus that the present invention is directed.

### BRIEF DESCRIPTION OF THE DRAWINGS

FIG. 1 is a front elevational view of a locating apparatus constructed in accordance with the present invention, the locating apparatus mounted on a pipeline buried beneath ground level.

FIG. 2 is a front elevational view of an elongated member formed of a plurality of interconnected segments.

FIG. 3 is a partially cutaway, front elevational view of one segment of the elongated member of FIG. 2.

FIG. 4 is a partially broken, front elevational view of the locating apparatus of FIG. 1 illustrating in more detail a mounting assembly of the locating apparatus of the present invention, the mounting assembly disposed on a section of an underground pipeline.

FIG. 5 is a partially broken, side elevational view of the mounting assembly of FIG. 4 secured to a section of an underground pipeline.

FIG. 6 is a partially broken, cross-sectional elevational view of another embodiment of the locating apparatus constructed in accordance with the present invention, an elongated telescoping member of the locating apparatus being shown in a retracted position.

FIG. 7 is a partially broken, elevational view of the locating apparatus of FIG. 6 herein, the elongated telescoping member of the locating apparatus is in an extended position.

### DETAILED DESCRIPTION OF THE PREFERRED EMBODIMENTS

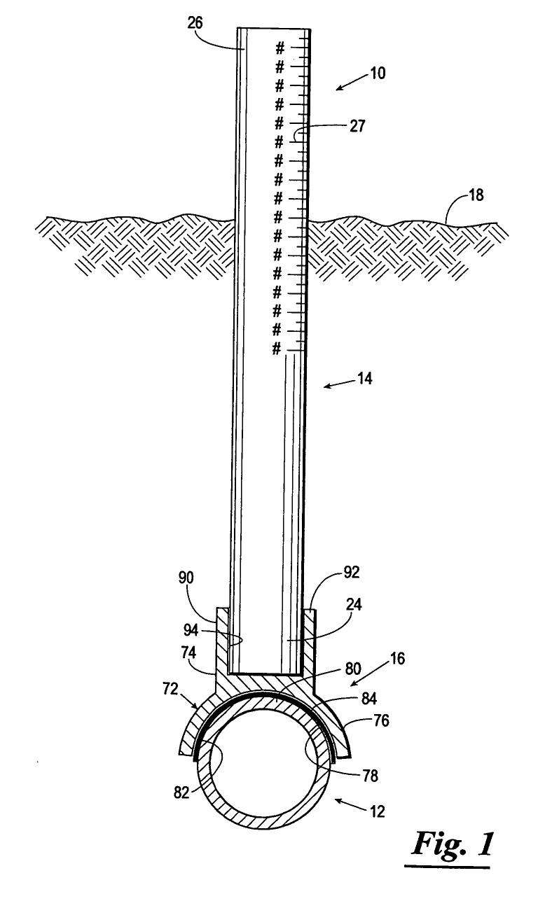

Referring now to the drawings, and more particularly to FIG. 1, shown therein is a subterranean object locating apparatus 10 constructed in accordance with the present invention. The subterranean object locating apparatus 10, also referred to as locating apparatus 10, is connected to a subterranean object, such as for example but not by way of limitation, a pipeline 12 so that one can readily determine the location and the depth to which the pipeline 12 is buried.

The locating apparatus 10 includes an elongated member 14 and a mounting assembly 16. The mounting assembly 16 is connectable to the pipeline 12 and to the elongated member 14 such that the elongated member 14 is disposed in an upward direction from the pipeline 12 so that a portion of the elongated member 14 extends a distance upwardly above ground level 18 substantially as shown in FIG. 1. That is, the mounting assembly 16 is connected to the subterranean object, such as the pipeline 12, and a proximate end portion 24 of the elongated member 14 is connected to the mounting assembly 16 such that a distal end portion 26 of the elongated member 14 extends above ground level 18 and is readily visible when the mounting assembly 16 is mounted on the pipeline 12 and the pipeline 12 is buried below ground level 18. While the pipeline 12 has been illustrated in the drawing as the particular subterranean object used in connection with the locating apparatus 10 of the present invention, it is to be understood that the subterranean object may be an electric line, a fiber optic line, or any other buried line or object.

The elongated member 14 includes a demarcation 27, the demarcation 27 desirably disposed between the proximate end portion 24 and the distal end portion 26 thereof. The demarcation 27 on the distal end portion 26 of the elongated member 14 provides visable information which enables one to readily determine the depth to which an object, such as the pipeline 12, is buried below the ground level 18.

The visible portion of the distal end portion 26 of the elongated member 14 can vary in length depending on the conditions of the specific location of the locating apparatus 10 and the depth of the pipeline 12 or other buried object or utility, among other factors. For example, if the area above the pipeline 12 has a thick overgrowth it may warrant that the elongated member 14 have a length sufficient such that the distal end portion 26 of the elongated member 14 extends a significant distance above ground level 18 such that the distal end 26 portion of the elongated member 14 be observable above the overgrowth. However, in any circumstance, it is desirable that the distal end portion 26 of the elongated member 14 preferably extends a distance above ground level 18 from about one foot to about six feet.

The elongated member 14 is desirably constructed of a weather resistant material such as, but not limited to, plastic, fiberglass, galvanized steel and the like. In the event that the subterranean object to be marked by the locating apparatus 10 is an electric line, it may be desirable that the mounting assembly 16 and elongated member 14 be constructed of a substantially non-conducting material. Additionally, the elongated member 14 should resist collection of water or debris, so that rust, freeze-thaw, or other damage by natural occurrences such as rain, snow, frost, and the like is prevented. It is also desirable that the elongated member 14 be constructed of an impact resistant, substantially rigid material so as to resist permanent deformation and thereby provide a more accurate correlation between the distal end portion 26 of the elongated member 14 situated above the ground level 18 and the depth that the pipeline 12 is buried.

Impact resistance is also a desirable property, particularly for the distal end portion 26 of the elongated member 14 that is situated above the ground level 18, so as to prevent or substantially reduce deformation or breakage of the elongated member 14 when the distal end portion 26 of the elongated member 14 extending above the ground level 18 is struck, pushed, or otherwise encountered by an external force, such as a motorized vehicle, livestock, wind, or any other force that may have a tendency to deform, bend, or break the elongated member 14.

The cross-sectional configuration of the elongated member 14 can vary widely and will depend to a large degree on the configuration and construction of the mounting assembly 16. Thus, the cross-sectional configuration of the elongated member 14 can be circular, square, triangular, rectangular and the like. Further, the elongated member 14 can be fabricated from solid materials, tubular materials and the like.

As previously stated, the demarcation 27 on the elongated member 14 provides a visual indication of the depth that the pipeline 12 is buried below ground level 18. The demarcation 27 may be in the form of intervals of metric or English measurements or any other commonly used form of measurement (FIG. 1); or color may be used to indicate various depths to which the pipeline 12 is buried. For example, the proximate end portion 24 of the elongated member 14 may be provided with a first band of a highly visable color, such as red, so as to indicate that the pipeline 14 is buried at a depth close to the ground level 18, i.e., the pipeline 14 is buried less than a predetermined distance, such as four (4) feet below ground level 18. A second band of a highly visable color, such as orange, may be positioned adjacent the first band of a highly visible color so as to indicate that the pipeline 14 is buried at a deeper depth than that when the first band of highly visable color is visable, while indicating that the pipeline is still buried at a depth fairly close to the ground level 18, i.e., the pipeline 14 is buried less than a predetermined depth, such as less than about eight (8) feet below ground level 18. A third band of a highly visable color, such as yellow, may be provided adjacent the second band of highly visable color to indicate that the pipeline 12 is buried below the ground level 18 at a depth greater than a predetermined depth, such as about eight feet, but at a depth less than a predetermined depth, such as about 12 feet. A fourth band of a highly visable color, such as blue, may be provided adjacent the third band of highly visable color so as to indicate that the pipeline 12 is buried at least a predetermined distance, such as at least about twelve feet, below the ground level 18. It should be noted that the length of the bands of highly visable colors can vary widely as can the numbers of bands of highly visible colors, but each band will generally vary from about four to six feet in length.

While the demarcation 27 has been described as being, numeric indicators and/or bands of highly visable colors, it should be understood that any conventional marking or measuring indicators positioned on the elongated member 14 can be employed as the demarcation 27 as long as a person can quickly determine the depth that the pipeline 18 is buried below ground level 18.

The demarcation 27, in addition to providing an indication of depth to which the object such as the pipeline 14 is buried, may also be used to indicate the nature of the subterranean object. For example, blue may indicate a water line, yellow may indicate a high pressure gas line, orange may indicate a fiber optic line, etc. In addition, oil companies frequently use color schemes to identify their pipelines. These same color schemes could be incorporated into the demarcation 27 of the elongated member 14 associated with such pipelines to indicate ownership of such pipelines.

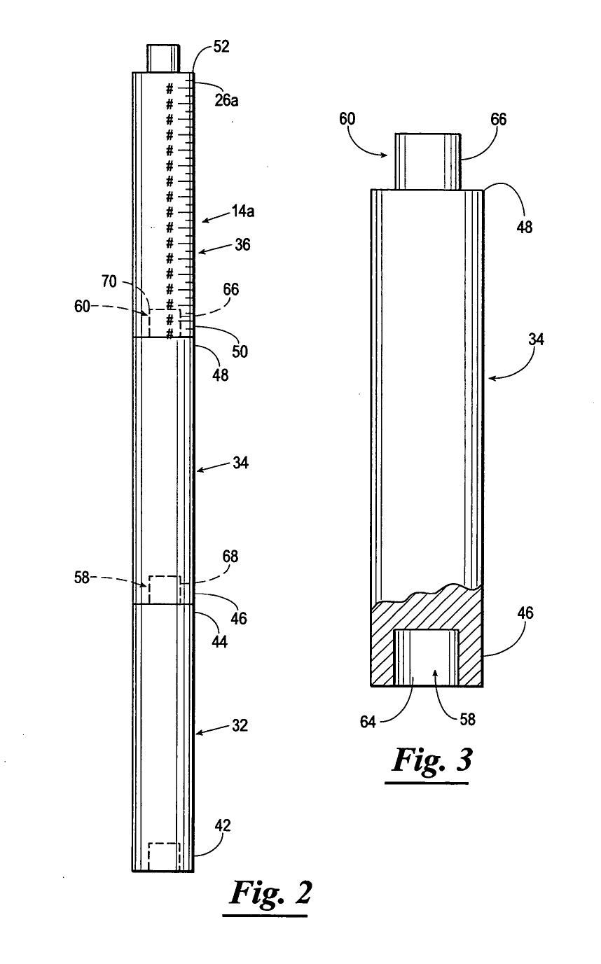

Referring now to FIG. 2 shown therein is an elongated member 14a formed of a plurality of sections or segments 32, 34, and 36. The elongated member 14a is shown as having three (3) sections or segments which have a desired length such that upon connecting the sections or segments together and connecting the lower most section or segment to the pipeline 14 via the mounting assembly 16, a portion of at least one of the sections, such as the section 36 defining a distal end portion 26a of the elongated member 14a extends a distance above ground level so that one can readily determine the depth at which the pipeline 14 is buried below ground level. That is, the overall length of the elongated member 14a can selectively adjusted by adding or subtracting the number of sections or segments utilized in the construction of the elongated member 14a. Thus, when the elevation of the ground level 18 increases, one or more additional sections or segments may be added so as to increase the overall length of the elongated member 14a so that at least a portion of the upper most section or segment of the elongated member 14a constituting the distal end portion 26a of the elongated member 14a is visible above ground level. Likewise, as the elevation of the ground level 18 decreases, one or more of the sections or segments, such as the section 36, of the elongated member 14a may be removed. Thus, the overall length of the elongated member 14a can be varied depending on conditions, such as but not limited to, pipeline depth, soil and weather conditions.

Each of the sections or segments 32, 34, and 36 of the elongated member 14a are similar in construction and the length of each of the sections or segments can vary widely. However, in order to provide the elongated member 14a with a desired structural integrity, the sections or segments 32, 34, and 36 of the elongated member 14a are desirably from about 3 to about 6 feet in length.

The section or segment 32 is provided with a first end 42 and a second end 44; the section or segment 34 is provided with a first end 46 and a second end 48; and the section or segment 36 is provided with a first end 50 and a second end 52. The first end 42 of the section or segment 32 is connected to the subterranean object, such as the pipeline 12 via the mounting assembly 16 in the same manner that elongated member 14 is connected to the pipeline 12 via the mounting assembly 16; and the second end 44 of the section or segment 32 is connected to the first end 46 of the section or segment 34 via a coupling assembly 58. The second end 48 of the section or segment 34 is connected to the first end 50 of the section or segment 36 via a coupling assembly 60.

Each of the coupling assemblies 58 and 60 include a male member and a female member and each of the sections or segments 32, 34, and 36 of the elongated member 14a are similar in construction and function. Thus, only the section or segment 34 will be described in detail with reference to FIG. 3.

The section or segment 34 is provided with a female member 64 of the coupling assembly 58 on the first end 46 thereof and a male member 66 of the coupling assembly 60 on the second end 48 thereof. The female member 64 is adapted to matingly receive a male member 68 provided on the second end 44 of the section or segment 36 (FIG. 2); and the male member 66 is adapted to matingly engage a female member 70 provided on the first end 50 of the section or segment 36 (FIG. 2).

The male members of each of the coupling assemblies, are provided on the second end of each of the sections or segments 32,34, and 36 and the female members of each of the coupling assemblies, are provided on the first end of each of the sections or segments 32,34, and 36. The advantage of having the male members of the coupling assemblies on the first end of each of the sections or segments 32,34, and 36 is to prevent accumulation of rain, snow, or debris in the female member of the coupling assemblies which could cause damage.

The male and female members of the coupling assemblies can have any suitable or structural configuration provided such that a secure connection is provided between adjacently disposed sections or segments of the elongated member 14a. For example, the male and female members of the coupling assemblies can be frictionally snapped together as illustrated in phantom in FIG. 2, or the male members may have one or more pins which are capable of connecting the male members to corresponding female members, or the male and female members of the coupling assemblies may be bolted, or banded together, or welded, glued, threadally connected and the like.

As previously stated, the elongated member 14 is connected to a buried subterranean object, such as the pipeline 12, via the mounting assembly 16 so that the distal end portion 26 of the elongated member 14 extends a visible distance above ground level 18. The elongated member 14a is also connected to a buried subterranean object, such as the pipeline 12 in a similar manner. As shown in FIGS. 1, 4 and 5, the mounting assembly 16 includes a saddle member 72 having a base 74 and a skirt portion 76. The base 74 and the skirt portion 76 are configured so as to be positionable on a portion of a peripheral surface 78 of the pipeline 12 and extend around a portion of the pipeline 12 so as to enhance stability of the saddle member 72 on the pipeline 12. That is, the base 74 is disposed on an upper portion 80 of the pipeline 12 and the skirt portion 76 extends from the base 74 so as to be positionable adjacent a middle portion 82 of the pipeline 12.

The mounting assembly 16 further includes a spacer or cushioning member or blanket 84 disposable between the upper portion 80 of the peripheral surface 78 of the pipeline 12 and the base 74 of the saddle member 72 and the middle portion 82 of the peripheral surface 78 of the pipeline 12 and the skirt portion 76 of the saddle member 72. The spacer or cushioning member or blanket 84 is desirably made of an elastomeric or compressible material so as to enhance connection of the saddle member 72 to the pipeline 12.

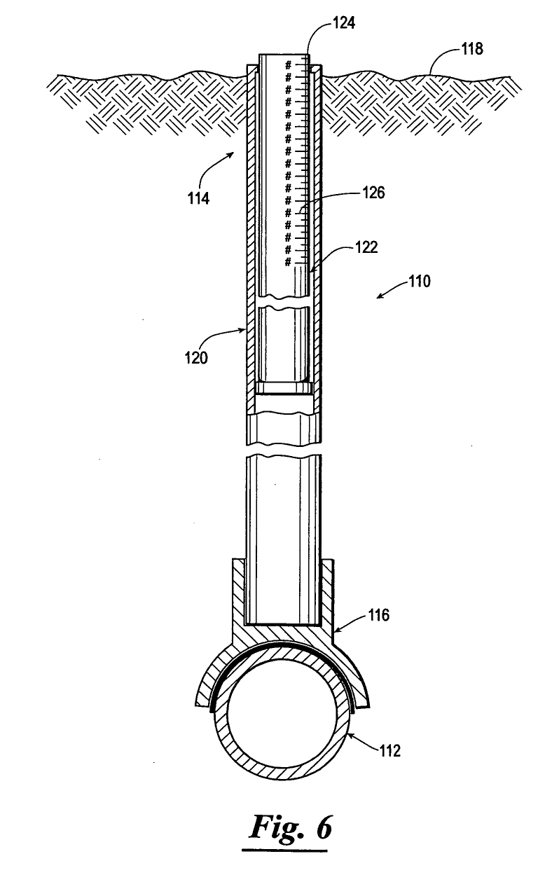

The mounting assembly 16 further includes a plurality of straps 86 and 88 (FIG. 5) for connecting the saddle member 72 to the pipeline 12. Any conventional straps can be used as the straps 86 and 88. In addition, while the straps 86 and 88 are shown, it should be understood that any number of connecting assemblies can be employed to connect the saddle member 72 to the subterranean object, such as the pipeline 12, including but not limited to bolts, adhesives, welds, flanges, brackets, magnets, and the like.

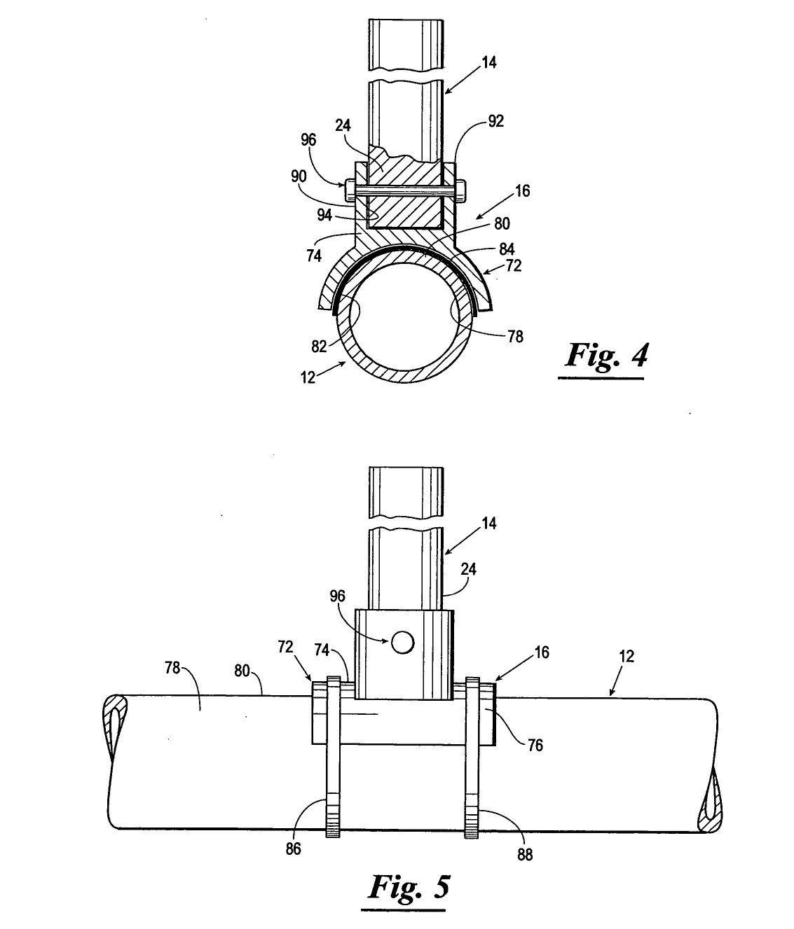

The saddle member 72 of the mounting assembly 16 desirably is provided with a pair of spatially disposed upwardly extending lugs 90 and 92 which cooperate to define a channel or recepticle 94 configured and sized to receive at least a portion of the proximate end portion 24 of the elongated member 14 so that the elongated member 14 can be securely connected to the pipeline 12 via the mounting assembly 16 substantially as shown. If desired connecting members, such as the bolt 96 can extend through an apparatus (not shown) formed through the lugs 86 and 88, respectfully (FIGS. 4 and 5), and the bolt 96 can be employed to stabilize and secure portion of the proximate end portion 24 of the elongated member 14 in the channel or recepticle 94 defined by the lugs 90 and 92. While the connecting or stabilizing members have been shown as the bolt 96, it should be understood that any suitable connectors can be employed to secure the elongated member 14 to the mounting assembly 16, such as welds, adhesives, brackets, clamps and the like.

The installation of the subterranean object locating apparatus 10 will now be described with reference to the pipeline 12. It is desirable to install the subterranean object locating apparatus 10 on the pipeline 12 when the pipeline 12 is uncovered and thus exposed. Initially, the mounting assembly 16 is connected to the pipeline 12 and thereafter the elongated member 14 is connected to the mounting assembly 16. Once the subterranean object locating apparatus 10 is in place, the pipeline 12, along with the mounting assembly 16, and the elongated member 14 are buried, care must be exercised to insure that the proximate end portion 26 of the elongated member 14 is readily visable above ground level 18 (FIG. 1). When the elongated member 14a is employed, the sections or segments, such as the sections or segments 32, 34, and 36 are connected as herein before described prior to burying the pipeline 12. Thus, when the pipeline 12 and a lower portion of the elongated member 14 are buried, the distal end portion 26 of the elongated member 14 extends above the ground level 18, allowing easy determination of the location and depth of the pipeline 12 thereby eliminating the need to estimate, dig, probe, or use expensive equipment to be located and determine the depth to which is pipeline 12 is buried.

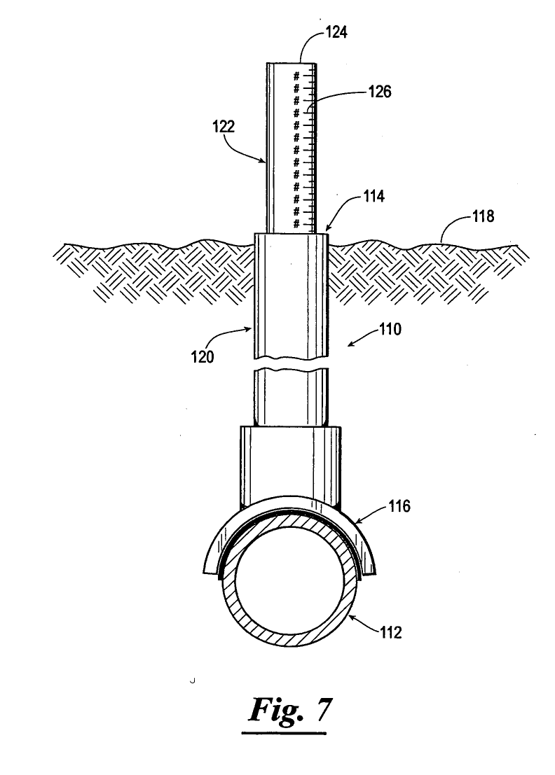

Referring now to FIGS. 6 and 7, shown therein is another embodiment of a subterranean object locating apparatus 110 constructed in accordance with the present invention. The subterranean object locating apparatus 110 is connected to a subterranean object, such as a pipeline 112 so that one can readily determine the location and the depth to which the pipeline 112 is buried. The subterranean object locating apparatus 110 (also referred to as the locating apparatus 110) includes a telescoping elongated member 114. The construction of the telescoping elongated member 114 permits the telescoping elongated member 114 to be moved to a retracted position (FIG. 6) when the telescoping elongated member 114 is not in use so as to prevent the telescoping elongated member 114 from interfering with roadside maintenance such as mowing and the like, and an extended position (FIG. 7) for providing information as to the depth that an object, such as the pipeline 112, is buried below ground level 118. A mounting assembly 116 is provided which is similar in construction and function to the mounting assembly 16 herein before described; and the connection of the telescoping elongated member 114 to the mounting assembly 116 is similar in construction and function as the connection of the elongated member 14 to the mounting assembly 16. Thus, only the telescoping elongated member 114 will be described in detail herein after with reference to FIGS. 6 and 7.

The elongated telescoping member 114 is provided with a plurality of elongated segments, such as elongated segments 120 and 122. The segment 120 is configured to telescopically receive the elongated segment 122 when the elongated telescoping member 114 is in the retracted position substantially as shown in FIG. 6. However, when the elongated telescoping member 114 is in the extended position as shown in FIG. 7, at least a portion of the elongated segment 122 is withdrawn from the elongated segment 120 so that a distal end portion 124 of the elongated segment 122 will be visible above ground level 118. At least the distal end portion 124 of the elongated segment 122 of the elongated telescoping member 114 is provided with a demarcation 126 which will provide a person with information as to the depth to which the pipeline 114 is buried below ground level 118. As previously noted, the demarcation 126 can be in the form of intervals of metric, English or other commonly used forms of measurement; and/or the demarcation 126 can be in the form of highly visible bands of color.

The construction of telescoping members which can be employed as the elongated telescoping member 114 of the locating apparatus 110 are well known in the art. Thus, no further comments or description of the elongated telescoping member 114 or the elongated segments 120 and 122 are believed necessary to enable one to make and use the elongated telescoping member 114.

The length and number of the elongated segments such as the elongated segments 120 and 122, employed in the construction of the elongated telescoping member 114 can vary widely. Similarly the cross-sectional configuration of the elongated segment of the elongated telescoping member 114 can vary provided the cross-sectional configuration of the elongated segment permits one to readily move the elongated telescoping member 114 between the retracted position (FIG. 6) and the extended position (FIG. 7).

The present invention is not to be limited in scope by the specific embodiments described herein, since such embodiments are intended as but single illustrations of one aspect of the invention and any functionally equivalent embodiments are within the scope of this invention. Indeed, various modifications of the invention in addition to those shown and described herein will become apparent to those skilled in the art from the foregoing description. Such modifications are intended to fall within the scope of the invention as defined in the following claims.

What is claimed is:

1. A subterranean object locating apparatus for designating a location of a subterranean object, comprising:
an elongated member, having a proximal end portion and a distal end portion; and
a mounting assembly connectable to the subterranean object and to the proximal end portion of the elongated member such that when the mounting assembly is connected to the subterranean object and the proximal end portion of the elongated member at least a portion of the distal end portion of the elongated member extends above ground level so as to be observable and thereby designate the location and depth to which the subterranean object is buried below ground level.

2. The subterranean object locating apparatus of claim 1 wherein the elongated member further includes a demarcation disposed on the elongated member for permitting one to determine the depth that the subterranean object is buried below ground level.

3. The subterranean object locating apparatus of claim 1 wherein the subterranean object is a pipeline.

4. The subterranean object locating apparatus of claim 1 wherein the mounting assembly comprises:
a saddle member having a base and a skirt portion, the base sized and configured to be disposed on a portion of an upper peripheral surface of the subterranean object, and the skirt portion sized and configured to overlap a portion of a side surface of the subterranean object, the base adapted to receive a portion of the proximate end portion of the elongated member for connecting the elongated member to the saddle a spacer positionable between the subterranean object and the saddle member; and
a connecting assembly for connecting the saddle member to the subterranean object.

5. A subterranean object locating apparatus for providing a location of a subterranean object, comprising:
an elongated member formed of a plurality of segments, each of the plurality of segments having a first end and a second end;
a coupling assembly for selectively connecting adjacently disposed first and second ends of the elongated segments; and
a mounting assembly connectable to the subterranean object and to the second end of a lower most disposed segment of the elongated member such that in a connected condition, at least a portion of the upper most segment of the elongated member extends upwardly above ground level and provides visual information as to the location and depth to which the subterranean object is buried.

6. The subterranean object locating apparatus of claim 5 wherein each segment of the elongated member has a length of from about 3 to 6 feet.

7. The subterranean object locating apparatus of claim 6 wherein the elongated member includes demarcation disposed along the length thereof for permitting one to determine the depth of the subterranean object below ground level.

8. A method of installing a subterranean object locating device on an object which is to be buried, comprising the steps of:
providing an elongated member, the elongated member having a proximal end portion and a distal end portion;
providing a mounting assembly;
connecting the mounting assembly to the subterranean object;
connecting the proximate end portion of the elongated member to the mounting assembly; and
burying the subterranean object, mounting assembly and at least portion of the elongated member such that at least a portion of the distal end portion of the elongated member extends above ground level for indicating the location and depth to which the subterranean object is buried.
